(19) United States
(12) Patent Application Publication
(10) Pub. No.: US 2025/0357677 A1
(43) Pub. Date: Nov. 20, 2025

(54) Multilayered Radar-Absorbing Elements Having Adaptable Properties For Microwave Absorption

(71) Applicant: Airbus Defence and Space GmbH, Taufkirchen (DE)

(72) Inventors: Dominik Santl, Taufkirchen (DE); Matthias Bleckmann, Taufkirchen (DE)

(73) Assignee: Airbus Defence and Space GmbH, Taufkirchen (DE)

(21) Appl. No.: 19/206,262

(22) Filed: May 13, 2025

(30) Foreign Application Priority Data
May 16, 2024 (DE) 102024113810.6

(51) Int. Cl. H01Q 17/00

(52) U.S. Cl. CPC H01Q 17/008; H01Q 17/005

(57) ABSTRACT

A multilayered radar-absorbing element having adaptable properties for microwave absorption for vehicle parts is described. The element includes a core layer having a first layer thickness, an insulating layer having a second layer thickness, and an outer absorption layer having a third layer thickness. The core layer is manufactured from a magnetically absorbent material. The insulating layer is manufactured from a material which is both electrically insulating and magnetically transmissive. The outer absorption layer is manufactured from a material which is both electrically conductive and magnetically transmissive. The insulating layer is arranged between the core layer and the outer absorption layer. Furthermore, a vehicle part having a plurality of such radar-absorbing elements and a method for producing such a vehicle part are described.

### FIELD OF THE INVENTION

The present disclosure relates to multilayered radar-absorbing elements having adaptable properties for microwave absorption and to vehicle parts comprising such elements and to vehicles (such as aircraft) having corresponding vehicle parts.

### BACKGROUND OF THE INVENTION

Military aircraft of the most recent generation are increasingly highly camouflaged, in particular against enemy radars. One part of the radar camouflage is represented by the shaping itself in this case. However, this is sometimes not possible. In particular, for example, the wing leading edges, air intakes, etc. can only be designed within certain limits in their shaping so as not to impair the respective function.

At such points, for example, radar-absorbing materials (RAM) and/or radar-absorbing structures (RAS) are therefore used in order to increase the absorption of radar waves and thus shrink the radar cross section. RAM and RAS can be constructed in this case both as a magnetic absorber and also as an electrical absorber. Both types of absorbers have their specific advantages. To produce both types of absorbers, for example, additives (electrically conductive for electrical absorbers or magnetic additives for magnetic absorbers) can be introduced into a polymer (fiber-reinforced or non-fiber-reinforced).

Up to this point, essentially electrical or magnetic absorbers are known. In combined absorbers, an independent setting of the properties is not possible. In principle, both magnetic and dielectric absorbers are known, as are combinations thereof. However, presently only mixtures made up of dielectric and magnetic particles are used in this case. Furthermore, combined (electrical and magnetic) absorbers are very complex to produce.

### BRIEF SUMMARY OF THE INVENTION

An aspect of the invention relates to providing a broadband dielectric and magnetic absorber, which is simple to produce, having targeted setting of the absorption properties.

According to a first aspect, a multilayered radar-absorbing element having adaptable properties for microwave absorption for vehicle parts is provided. The element comprises a core layer having a first layer thickness, an insulating layer having a second layer thickness, and an outer absorption layer having a third layer thickness. The core layer is manufactured from a magnetically absorbent material. The insulating layer is manufactured from a both electrically insulating and magnetically transmissive material. The outer absorption layer is manufactured from a both electrically conductive and magnetically transmissive material. The insulating layer is arranged between the core layer and the outer absorption layer.

Vehicles, in particular in the military sector (such as military aircraft, ships, etc.) are often equipped with camouflaging technologies/stealth technology in order to prevent identification by the enemy by means of radar technology. A radar emits radar waves to identify objects, which are reflected by the object to be identified. The location and the movement of the object can be identified by the measurement of the reflection. A radar beam fundamentally comprises electromagnetic waves here, which comprise both electrical and also magnetic components. An identification by radar can be prevented in particular here by the reduction of the radar cross section (signature area or effective reflection area) of the object (for example, an aircraft). Such a reduction of the radar cross section results here in particular from corresponding design of the surface geometry (“geometric absorber”). For example, in order to avoid a reflection of radar energy back to the transmitter, the surfaces are inclined relative thereto or sharp edges are presented. However, limits are placed on such a corresponding geometric design at some points, for example, on the wing edges or engine intakes of an aircraft, so as not to impair their function. Moreover, a good geometric shape can reduce the radar cross section by a factor of 10 to 100. However, an even higher factor is difficult to achieve since due to Huygens' principle, even an extremely inclined plate radiates radar energy back to the transmitter, only substantially less than with perpendicular incidence of the signal. Therefore, radar-absorbing materials are indispensable for a further reduction of the radar cross section. However, these are usually less effective against low-frequency radars. In particular at the mentioned points, such as wing edges and engine intakes, radar-absorbing materials (RAM) and/or radar-absorbing structures (RAS) can be used to further reduce the radar cross section. For such structures, electrical and magnetic absorbers are used, wherein typically mixtures of magnetically absorbing particles and electrically absorbing particles are used, which are introduced into the part, for example, into a polymer, which can be fiber-reinforced or non-fiber-reinforced. Problems also result here in particular in ensuring the desired arrangement of the individual particles in relation to one another. Moreover, an independent setting of the absorption properties is not possible in combined absorber materials.

The core concept of the invention is now to combine the magnetic and electrical absorbers with one another, in particular in a common element. The radar-absorbing element is a microscopic element here, which is provided, for example, in an order of magnitude of 1 μm to 10 μm. Such a radar-absorbing element can be provided, for example, as round, essentially spherical particles or as elongated fibers. Flake-like formations (“flakes”) are a further option, in which, for example, the core layer or the material of the core layer is initially ground and then coated using the corresponding further layers. A large number of such radar-absorbing elements can then be accommodated during the manufacturing in a vehicle part (for example, on the described wing edges, but also over the full surface), but also in any other part which is to be protected from radar identification. For example, corresponding particles can be introduced into a base material (for example, a matrix material of a fiber-reinforced plastic or a plastic material in general, such as a polymer, or also a lacquer or lacquer system) before the curing. Furthermore, the disclosed radar-absorbing elements can also be used in ceramic materials. The term “base material” is therefore to be understood as open and all-inclusive in this disclosure. In principle, all possible base materials are comprised thereby. If the radar-absorbing elements are provided as fibers, they can moreover be accommodated/introduced, for example, in fiber-reinforced plastic parts in the fiber bundles existing in any case (for example, made up of glass fibers) or woven with the glass fibers. The individual radar-absorbing elements each unify the absorption of magnetic waves and of electrical waves in the same element here.

The core layer is used in this case to absorb magnetic components of the radar energy. The outer absorption layer, in contrast, is used to absorb the electrical components of the radar energy. To absorb the electrical components of the radar energy, the outer absorption layer has to have a certain electrical conductivity. For the magnetic absorbers (i.e. the core layer), the individual magnetic absorbers (i.e. in particular the individual core layers of a plurality of the radar-absorbing elements) have to be electrically insulated from one another (i.e. not electrically conductive), however. This insulation is provided by the insulating layer, which is located between the core layer and the outer absorption layer. The outer absorption layer accordingly has a corresponding ohmic resistance, but is transparent for the magnetic components of the radar energy, so that these can penetrate to the core layer and be absorbed there. For the same reason, the insulating layer is also magnetically transparent and, in order to ensure the electrical insulation, electrically nonconductive.

The electrical resistance can be adapted in a customized manner by the radar-absorbing elements described here by the selection of the material and the layer thickness (third layer thickness) of the outer absorption layer. The magnetic moment can also be adapted by the selection of the material or by the diameter (first layer thickness) of the inner core layer. The advantage of the invention is furthermore that the setting of the magnetic and electrical properties (wherein this means the setting of the corresponding parameters before the manufacturing of the part (i.e. in particular before the manufacturing of the radar-absorbing elements) for the desired application, but not in running operation) can take place independently of one another. An optimum adaptation of the absorbing properties with respect to the bandwidth and the absorption capacity for the respective application can thus take place, which was not thus previously possible in the prior art. It is also conceivable to accommodate further layers, for example, made of further magnetically or electrically absorbing materials having different absorption properties, in order to further optimize the absorption properties as a whole. It is always to be taken into consideration here that the correspondingly required insulation of the magnetic absorbers is ensured.

To achieve certain desired absorption properties, i.e. in particular a desired bandwidth and a desired absorption capacity, for example, a computer simulation can be used which takes into consideration the geometry of the respective part (for example, an aircraft wing), and the desired absorbing properties and then outputs the corresponding values for the layer thicknesses, materials, and for the arrangement of the radar-absorbing elements in the part. The radar-absorbing elements can then be manufactured on the basis of these outputs and embedded in the part. It is also conceivable to use artificial intelligence (AI), for example, using machine learning technologies such as neural networks, in the determination of the parameters.

According to one embodiment, the material of the core layer comprises a ferromagnetic material.

Ferromagnetic materials are understood as materials having a magnetic permeability of μᵣ>>1. Such ferromagnetic materials ensure absorption of the magnetic field components of the incident radar waves. The corresponding physical mechanisms are known to a person skilled in the art and therefore will not be explained in detail here. The magnetic permeability μᵣ of the core layer is preferably between 500 and 1,000,000.

According to a further embodiment, the ferromagnetic material comprises an alloy based on iron, cobalt, or nickel. Furthermore, ferrites or other materials having magnetic moments are also conceivable.

According to a further embodiment, the material of the insulating layer comprises a material which is both nonferromagnetic and electrically insulating.

Such a material is magnetically transparent and moreover electrically insulates the core layers of individual ones of the radar-absorbing elements from one another. The magnetic field components can thus penetrate to the core layer and are then absorbed there.

According to a further embodiment, the material of the insulating layer comprises a glass and/or a ceramic material.

Such a glass and/or ceramic material is, on the one hand, mechanically resistant and, on the other hand, both magnetically permeable and electrically insulating and is therefore well suitable for the purposes of the disclosed radar-absorbing elements.

According to a further embodiment, the material of the outer absorption layer comprises a specific ohmic resistance in the range between 0.01 Ω·mm²/m and 50 Ω·mm²/m.

For a good electrical absorber, an ohmic resistance is necessary, which cannot be excessively large (i.e. weak electrical power) or excessively small (insufficient conversion of the electromagnetic energy into heat), however. The specified range has proven to be advantageous for the purposes of the present disclosure.

According to a further embodiment, the multilayered radar-absorbing element furthermore comprises an insulating finishing layer. The insulating finishing layer is manufactured from a material which is both electrically insulating and magnetically transmissive.

According to a further embodiment, the element has a particulate formation in the form of a sphere. The core layer, the insulating layer, and the outer absorption layer form concentric spherical shells.

In this design, the radar-absorbing elements can be introduced in a simple manner into a base material, for example, into a base material (which can be, for example, a matrix material of a fiber-reinforced plastic and can comprise, for example, a polymer material).

Moreover, it is also conceivable to introduce such particles into a part during additive manufacturing thereof.

According to a further embodiment, the element has a fibrous formation in the form of an elongated fiber. The core layer, the insulating layer, and the outer absorption layer are arranged concentrically to one another in the cross section of the fiber.

Such elongated fibers are suitable in particular for use in fiber-reinforced plastic parts. For example, the radar-absorbing elements, if they are provided in the form of fibers, can be woven with reinforcing fibers (e.g., glass fibers, carbon fibers, aramid fibers, etc.) or also accommodated in corresponding fiber bundles. In particular the desired distribution of the radar-absorbing elements in the part can thus be controlled very precisely. However, the radar-absorbing elements in the form of fibers do not have to be woven with reinforcing fibers, but rather can also be accommodated as such in a corresponding matrix material. Furthermore, the radar-absorbing elements in fiber form can also be used in parts which are not designed as fiber-reinforced plastic components.

According to a second aspect, a vehicle part is provided. The vehicle part comprises a base material and a plurality of multilayered radar-absorbing elements according to any of the embodiments described here. The plurality of multilayered radar-absorbing elements are embedded at least in some sections in the base material and thus strengthen an absorption of radar waves by the vehicle part.

For example, the radar-absorbing elements can be accommodated in vehicle parts, for example, in aircraft, where the “geometric absorption” of radar waves is restricted due to functional restrictions. Embedding at least in some sections is to be understood here, for example, as embedding only at the wing edge (or in general at locally isolated points of the part). However, the radar-absorbing elements can also be accommodated in vehicle parts other than wings.

According to one embodiment, the base material comprises a fiber-reinforced plastic material.

A fiber-reinforced plastic material can be, for example, a composite part having glass, carbon, or aramid fibers (or any other type of reinforcing fibers) which are embedded in a matrix material, such as a polymer matrix. Such a composite part can be manufactured in a typical manner, wherein the radar-absorbing elements are introduced at a suitable time, however, before the matrix material is cured. Since the process of manufacturing a composite part is known except for the embedding of the radar-absorbing elements and is not essential to the invention, it will not be discussed in more detail here.

According to a further embodiment, the vehicle part is an aircraft wing. The aircraft wing has a wing edge. The plurality of multilayered radar-absorbing elements are embedded in the base material at least in an area of the wing edge.

According to a third aspect, a vehicle is provided. The vehicle comprises a vehicle shell and at least one vehicle part according to one of the embodiments described herein.

The vehicle can be, for example, an aircraft, spacecraft, ship, a land vehicle, or any other vehicle. The vehicle part can be any part of the vehicle which is to provide radar shielding, such as shell components in particular, such as aircraft wings in an aircraft in a nonrestrictive example.

According to a fourth aspect, a method for producing a vehicle part according to one of the embodiments described herein is provided. The method comprises the following steps: providing the base material, providing a desired geometry of the vehicle part, determining the first layer thickness, the second layer thickness, and the third layer thickness of the multilayered radar-absorbing elements on the basis of a desired radar absorption behavior and the geometry of the vehicle part, determining an amount and the distribution of the multilayered radar-absorbing elements within the base material on the basis of the desired radar absorption behavior and the geometry of the vehicle part, providing the determined amount of multilayered radar-absorbing elements according to the result of the determinations, and introducing the provided multilayered radar-absorbing elements into the base material during the production of the vehicle part.

If the vehicle part to be manufactured is, for example, a fiber-reinforced plastic part, the base material can be, for example, a matrix material of a fiber-reinforced plastic (such as a polymer material), into which reinforcing fibers are introduced in a known manner and which is cured in order to form the vehicle part. The radar-absorbing elements can be introduced into such a matrix material at a suitable point and in a suitable amount, so that a desired absorption behavior for radar energy is achieved. The radar-absorbing elements can be provided here in any suitable form, for example, as essentially spherical particles or as fibers, as described herein. However, it is to be noted that the radar-absorbing elements according to the invention can also be used in any other suitable base material.

Providing the base material can comprise, for example, providing a matrix material of a fiber composite part, but also any other base material into which the radar-absorbing elements are to be embedded.

The desired geometry of the vehicle part results during the design of the vehicle part in the design phase and can be, for example, a CAD model of the vehicle part. The desired radar absorption behavior (for example, with respect to the bandwidth and the absorption capacity) results in particular from the application. In general, the radar absorption behavior is moreover also based on the geometry of the respective vehicle part. In the design of vehicles having stealth technology, the radar cross section is thus typically already reduced as much as possible by selecting a suitable geometry of the design. However, this is not completely possible at all positions due to functional boundary conditions. For example, a further reduction of the radar cross section can be necessary at the wing edges or engine intakes of a vehicle, which can be carried out by suitable introduction of radar-absorbing elements. The radar absorption behavior of the vehicle part is influenced here in particular by the properties of the radar-absorbing elements and their amount, arrangement, and respective concentration in the vehicle part. To determine the desired radar absorption behavior, these properties of the radar-absorbing elements, in particular the layer thicknesses of the core layer, the insulating layer, and the outer absorption layer as well as the materials thereof, and the amount and distribution of the individual radar-absorbing elements in the vehicle part can be determined in consideration of the desired radar absorption behavior and the predetermined geometry either empirically or by means of a computational model or a computer simulation. In a computer simulation, it is moreover also conceivable to use a machine learning model, for example, having neural networks. An empirical determination is to be understood as an experimental approach by variation of the parameters to the desired radar absorption behavior (for example, by corresponding measurements in the laboratory).

After the properties of the radar-absorbing elements and also the amount and distribution thereof in the vehicle part have been determined, the corresponding radar-absorbing elements are provided or manufactured. The core layers of the radar-absorbing elements are coated/functionalized using the insulating layer and the outer absorption layer here, for example, by means of a corresponding chemical/physical method. Such methods can comprise, for example, a silicon coating or a physical vapor deposition (PVD). However, all other suitable coating methods are also fundamentally conceivable. In particular, different coating methods can also be used for the individual layers. In fibrous designs, as described herein, the core layer, when it is drawn out of the melt, can moreover, for example, be drawn through further corresponding baths, for example in the case of the outer absorption layer through metallic baths, in order to apply the corresponding layer.

In a final step, the already radar-absorbing elements are then introduced into the base material during the manufacturing of the vehicle part. This can be carried out, for example, by corresponding introduction into a matrix material of a fiber composite part.

According to one embodiment, the introduction of the multilayered radar-absorbing elements comprises at least one of the following: directly introducing the multilayered radar-absorbing elements into the base material or introducing the multilayered radar-absorbing elements as part of a fiber bundle of a fiber-reinforced vehicle part, wherein in the latter case (introducing as part of a fiber bundle), the multilayered radar-absorbing elements have a fibrous formation in the form of elongated fibers, and wherein the base material is a matrix material of the fiber-reinforced vehicle part.

Directly introducing is, for example, corresponding scattering/mixing into a matrix material of a fiber composite part (if one is provided) before its curing, into a plastic material without reinforcing fibers before its curing, introducing into a base material during additive manufacturing (for example, during 3D printing), and the like. In particular if the vehicle part is a fiber composite part and the radar-absorbing elements are provided in the form of elongated fibers, these can alternatively also, instead of introducing them directly into the matrix material, be woven with the reinforcing fibers (such as glass fibers, aramid fibers, carbon fibers) or introduced in another manner into corresponding fiber bundles (for example, the fibrous radar-absorbing elements can be introduced into a corresponding preform). This enables particularly good localization and control of the concentration of the individual radar-absorbing elements in the vehicle part. Moreover, the radar-absorbing elements can then additionally contribute to a mechanical stabilization. In principle, however, any other suitable type of introduction is also conceivable.

### BRIEF DESCRIPTION OF THE DRAWINGS

Exemplary embodiments are described in more detail hereinafter on the basis of the appended drawings. The illustrations are schematic and are not to scale. Identical reference signs refer to identical or similar elements. In the figures:

FIG. 1 shows a schematic view of spherical multilayered particles as radar-absorbing elements, which comprise both magnetically absorbing and electrically absorbing concentric spherical shells.

FIG. 2 shows a schematic cross-sectional view of the spherical multilayered particle from FIG. 1 along section line A-A of FIG. 1, or a perpendicular sectional view through the fibrous radar-absorbing elements of FIG. 3 along section line C-C.

FIG. 3 shows a schematic perspective view of radar-absorbing elements in the form of fibers, which comprise both magnetically absorbing and electrically absorbing concentric layers.

FIG. 4 shows a schematic longitudinal cross-sectional view of the radar-absorbing elements in the form of fibers from FIG. 3 along section line B-B.

FIG. 5 shows a schematic view of an aircraft which has two aircraft wings having radar-absorbing elements introduced into their wing edges.

FIG. 6 shows a flow chart of a method for producing a part having enhanced radar absorption.

### DETAILED DESCRIPTION

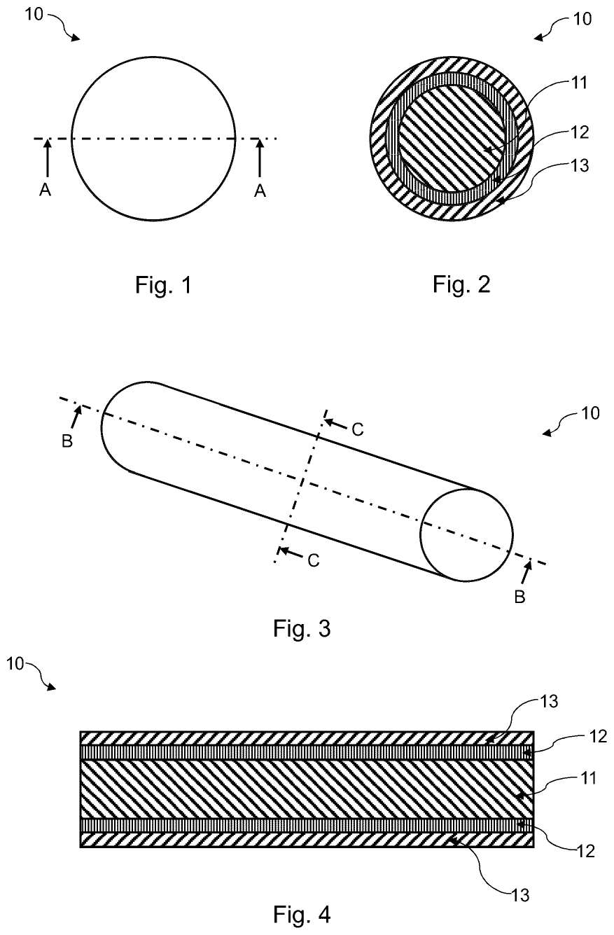

FIG. 1 very schematically shows a view of a multilayered radar-absorbing element 10 in the form of spherical particles in an exterior view. FIG. 2 shows the radar-absorbing element 10 of FIG. 1 in a cross-sectional view along section line A-A. Furthermore, FIG. 2 shows the identical perpendicular cross section through a multilayered radar-absorbing element 10 in the form of a fiber, which is described below with reference to FIGS. 3 and 4.

The radar-absorbing element 10 of FIG. 1 has a core layer 11, an insulating layer 12, and an outer absorption layer 13. The core layer 11, the insulating layer 12, and the outer absorption layer 13 are provided in the configuration of FIG. 1 in the form of concentric spherical shells, wherein the core layer 11 corresponds to the inner core of the particle (i.e. the radar-absorbing element 10) and the outer absorption layer 13 corresponds to the outermost layer of the particle. The insulating layer 12 is arranged between the core layer 11 and the outer absorption layer 13 and connects them to one another.

The core layer 11 is manufactured from a magnetically absorbing material, i.e. in particular a material having a high magnetic permeability, in particular a ferromagnetic material. The insulating layer 12 is manufactured from a material which is both electrically insulating and magnetically transmissive, i.e. a material which lets magnetic waves pass essentially unobstructed. The outer absorption layer 13 is in turn manufactured from a material which is both electrically conductive and magnetically transmissive.

The core layer 11 is used here to absorb the magnetic components of the radar energy. For this purpose, the outer layers (i.e. the insulating layer 12 and the outer absorption layer 13) have to be magnetically transparent so that the magnetic waves can penetrate to the core layer 11. The outer absorption layer, in contrast, is used to absorb the electrical components of the radar energy. To absorb the electrical components of the radar energy, the outer absorption layer 13 has to have a certain electrical conductivity. For the magnetic absorbers (i.e. the core layer 11), the individual magnetic absorbers (i.e. in particular the individual core layers 11 of a plurality of the radar-absorbing elements) have to be electrically insulated from (i.e. not electrically conductive with) one another, however. This insulation is provided by the insulating layer 12, which is located between the core layer 11 and the outer absorption layer 13. The outer absorption layer 13 accordingly has, on the one hand, a corresponding ohmic resistance but, on the other hand, is transparent for the magnetic components of the radar energy, so that they can penetrate to the core layer 11 and are absorbed there. For the same reason, the insulating layer 12 is also magnetically transparent and, in order to ensure the electrical insulation, electrically nonconductive. Using this arrangement, a combined absorption of the electrical and magnetic components of the radar energy is enabled by a common multilayered radar-absorbing element 10. An undesired incorrect relative concentration of the individual particles in relation to one another, which can occur, for example, with separate electrically and magnetically absorbing particles, is thus in particular avoided. In particular, the formation of agglomerations of the individual magnetic and electrical particles is thus avoided from the outset, which enables simpler processing technology.

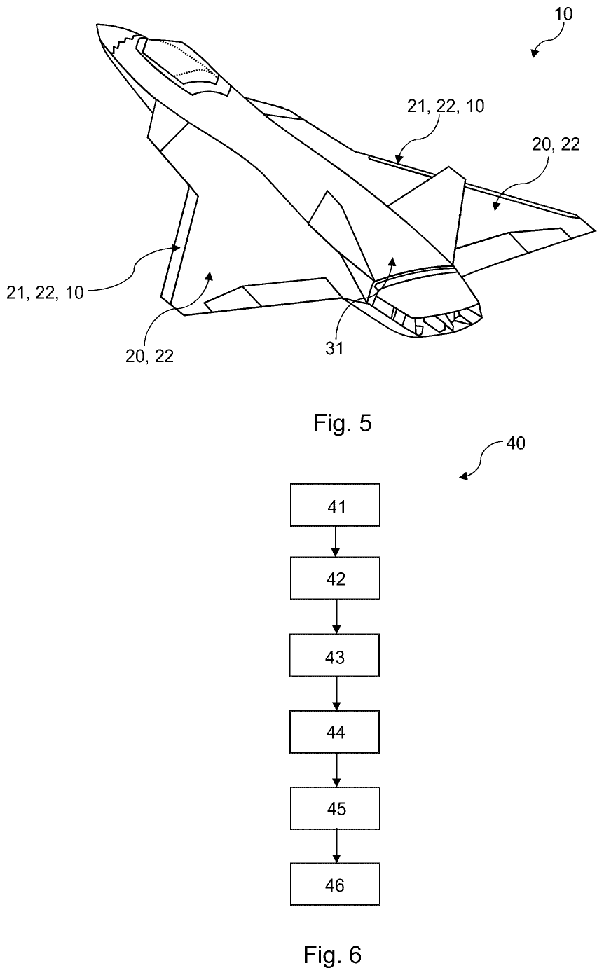

To improve the radar absorption of a component or a part, such as a vehicle part 20 (for example, FIG. 5 (aircraft wing 20)), a plurality of such radar-absorbing elements 10 can be introduced into a base material 22 (not shown in FIGS. 1 to 4, see FIG. 5). The introduction of such radar-absorbing elements 10 can take place here in any suitable manner, in particular uniformly over the entire part, locally bounded in the part, with varying concentrations across the part, or in any other suitable manner, depending on the desired radar absorption behavior. Furthermore, the overall radar absorption behavior can be set by the selection of correspondingly matched materials (i.e. materials having corresponding properties (e.g., ohmic resistance, magnetic permeability, etc.)) and layer thicknesses of the layers 11, 12, 13. A further parameter for setting the desired radar absorption behavior is the arrangement, distribution, and/or concentration of the radar-absorbing elements 10 in the vehicle part.

FIGS. 3 and 4 show an alternative design of the radar-absorbing element 10, in which the radar-absorbing element 10 is designed as an elongated fiber. FIG. 3 shows the radar-absorbing element 10 in a perspective view from the outside. FIG. 4 shows the radar-absorbing element 10 in a longitudinal cross section along section line B-B. Since the fibers are designed as round/cylindrical, FIG. 2, described above with reference to the radar-absorbing element 10 in the form of spherical particles, can also be viewed as a perpendicular cross section along section line C-C of the fibrous radar-absorbing element 10 of FIG. 4.

The fibrous radar-absorbing element 10 of FIGS. 3 and 4 also has a core layer 11, an insulating layer 12, and an outer absorption layer 13. The above statements with respect to these individual layers 11, 12, 13 of the spherical radar-absorbing element/particle 10 are also valid in their entirety for the fibrous design and are therefore not repeated here for the sake of brevity. The design of FIGS. 3 and 4 differs from the design of FIG. 1, however, in that the layers 11, 12, 13 are not provided as concentric spherical shells, but as concentric cylindrical layers.

The design of the radar-absorbing elements 10 as fibers according to FIGS. 3 and 4 is advantageous in particular for fiber-reinforced composite parts, since the radar-absorbing elements 10 can be woven with the reinforcing fibers provided in any case or introduced in another way into the fiber bundles of the reinforcing fibers, for example, as already described herein above.

FIG. 5 shows an exemplary vehicle 10 in the form of an aircraft 10. It is to be noted that the invention can also be used in other vehicles, such as ships, spacecraft, and the like. The aircraft 10 comprises a vehicle shell 31 and two aircraft wings 20 (or vehicle parts 20 in general). Each of the aircraft wings 20 is in general manufactured from a base material 22, such as a fiber-reinforced plastic as a composite part, and comprises in each case a wing edge 21 (or part edge 21 in general). A plurality of the above-described radar-absorbing elements 10 is accommodated in each of the wing edges 21, which thus absorb radar energy and reduce the radar cross section. However, it is to be noted that the wing edges 21 are only used as an example of the accommodation of the radar-absorbing elements 10 and the radar-absorbing elements 10 can in principle also be accommodated at any other desired point in a locally bounded manner or also across the entire vehicle part 20 or across the entire vehicle shell 31.

FIG. 6 shows a flow chart of a method 40 for producing a vehicle part 20 (FIG. 4). The method 40 begins with providing 41 a base material 22 (for example, a matrix material of a fiber composite part, a preform of such a composite part, a plastic material, a lacquer system, etc.). Furthermore, in step 42, a desired geometry (i.e. the structural form of the vehicle part 20) is provided, for example, in the form of a CAD model.

Subsequently, in steps 43 and 44, which can take place either successively/iteratively or also simultaneously, the required properties for the radar-absorbing elements 10 (step 43) and the required amount and distribution thereof in the vehicle part 20 (step 44) are determined. To determine the distribution, in particular locations within the base material 22 are determined at which the radar-absorbing elements 10 are to be introduced in order to achieve the desired radar absorption behavior. The properties of the radar-absorbing elements 10 in particular relate to their layer thicknesses and materials, which are also selected so as to achieve the desired radar absorption behavior. Both the properties of the radar-absorbing elements (step 43) and also the amount and distribution (step 44) are determined here on the basis of the desired radar absorption behavior and the desired geometry, for example, empirically or on the basis of a computer simulation (or also in any other suitable manner). A computer simulation considers, for example, the desired radar absorption behavior and the geometry of the vehicle part 20 as input parameters and then determines the respective output parameters. Optionally, a computer simulation can also use a machine learning model having neural networks, which were previously trained on the basis of training data. However, other types of determination are also possible.

After the determination of the properties and the amount and distribution of the radar-absorbing elements 10, in step 45, a certain amount of radar-absorbing elements 10 which have the determined properties is provided. The provision can comprise manufacturing the corresponding radar-absorbing elements 10, as described above herein. In step 46, these multilayered radar-absorbing elements 10 are then introduced into the base material 22, for example, by corresponding scattering or another type of introduction into a matrix material of a fiber composite part or into another material (for example, in general a plastic material or a lacquer) before its curing. For example, the radar-absorbing elements 10 can also be applied to reinforcing fibers of a fiber composite part, which are then infiltrated in a typical manner with a matrix material/resin. If the vehicle part to be manufactured is a fiber composite part having reinforcing fibers and the radar-absorbing elements 10 are provided in the form of fibers, they can moreover be woven accordingly with the reinforcing fibers or introduced in another way into strands of the reinforcing fibers before they are introduced into the matrix material and the matrix material is cured. The base material 22 can moreover, for example, also be a lacquer or lacquer system, into which the radar-absorbing elements 10 are introduced. The application of the present disclosure is not fundamentally restricted to specific base materials 22, but rather can be used with all conceivable base materials 22. In this sense, the concept of base material 22 is to be understood as open and all-inclusive.

In addition, it is to be noted that “comprising” or “having” does not exclude other elements or steps and “a” or “one” does not exclude multiples. Furthermore, it is to be noted that features or steps which have been described with reference to one of the above exemplary embodiments can also be used in combination with other features or steps of other above-described exemplary embodiments. Reference signs in the claims are not to be viewed as a restriction.

### LIST OF REFERENCE SIGNS

10 multilayered radar-absorbing element
11 core layer
12 insulating layer
13 outer absorption layer
14 insulating finishing layer
A-A cross section through particle
B-B longitudinal section through fiber
C-C perpendicular section through fiber
20 vehicle part (for example, aircraft wing)
21 part edge (for example, wing edge)
22 base material
30 vehicle (for example, aircraft)
31 vehicle shell
40 method for producing a vehicle part
41 providing the base material
42 providing a geometry
43 determining layer thicknesses
44 determining amount and distribution of the radar-absorbing elements
45 providing radar-absorbing elements
46 introducing the radar-absorbing elements

1. A multilayered radar-absorbing element having adaptable properties for microwave absorption for vehicle parts, comprising:
a core layer having a first layer thickness;
an insulating layer having a second layer thickness; and
an outer absorption layer having a third layer thickness;
wherein the core layer is manufactured from a magnetically absorbing material;
wherein the insulating layer is manufactured from a material which is both electrically insulating and magnetically transmissive;
wherein the outer absorption layer is manufactured from a material which is both electrically conductive and magnetically transmissive; and
wherein the insulating layer is arranged between the core layer and the outer absorption layer.

2. The multilayered radar-absorbing element as claimed in claim 1, wherein the material of the core layer comprises a ferromagnetic material.

3. The multilayered radar-absorbing element as claimed in claim 2, wherein the ferromagnetic material comprises an alloy based on iron, cobalt, or nickel.

4. The multilayered radar-absorbing element as claimed in claim 1, wherein the material of the insulating layer comprises a material which is both nonferromagnetic and electrically insulating.

5. The multilayered radar-absorbing element as claimed in claim 4, wherein the material of the insulating layer comprises a glass and/or a ceramic material.

6. The multilayered radar-absorbing element as claimed in claim 1, wherein the material of the outer absorption layer comprises a specific resistance in a range between 0.01 Ω·mm²/m and 50 Ω·mm²/m.

7. The multilayered radar-absorbing element as claimed in claim 1, further comprising an insulating finishing layer;
wherein the insulating finishing layer is manufactured from a material which is both electrically insulating and magnetically transmissive.

8. The multilayered radar-absorbing element as claimed in claim 1, wherein the element has a particulate formation in a form of a sphere; and
wherein the core layer, the insulating layer, and the outer absorption layer form concentric spherical shells.

9. The multilayered radar-absorbing element as claimed in claim 1, wherein the element has a fibrous formation in a form of an elongated fiber; and
wherein the core layer, the insulating layer and the outer absorption layer are arranged concentrically to one another in a cross section of the fiber.

10. A vehicle part, comprising:
a base material; and
a plurality of multilayered radar-absorbing elements as claimed in claim 1;
wherein the plurality of multilayered radar-absorbing elements is embedded at least in some sections in the base material and thus strengthen an absorption of radar waves by the vehicle part.

11. The vehicle part as claimed in claim 10, wherein the base material comprises a fiber-reinforced plastic material.

12. The vehicle part as claimed in claim 10, wherein the vehicle part is an aircraft wing;
wherein the aircraft wing has a wing edge; and
wherein the plurality of multilayered radar-absorbing elements is embedded in the base material at least in an area of the wing edge.

13. A vehicle, comprising:
a vehicle shell; and
at least one vehicle part as claimed in claim 10.

14. A method for producing a vehicle part as claimed in claim 10, the method comprising:
providing the base material;
providing a desired geometry of the vehicle part;
determining the first layer thickness, the second layer thickness, and the third layer thickness of the multilayered radar-absorbing elements on the basis of a desired radar absorption behavior and the geometry of the vehicle part;
determining an amount and a distribution of the multilayered radar-absorbing elements within the base material on the basis of the desired radar absorption behavior and the geometry of the vehicle part;
providing the determined amount of multilayered radar-absorbing elements according to the result of the determinations; and
introducing the provided multilayered radar-absorbing elements into the base material during the production of the vehicle part.

15. The method as claimed in claim 14, wherein introducing the multilayered radar-absorbing elements comprises at least one of the following:
directly introducing the multilayered radar-absorbing elements into the base material; or
introducing the multilayered radar-absorbing elements as part of a fiber bundle of a fiber-reinforced vehicle part, wherein the multilayered radar-absorbing elements have a fibrous formation in the form of elongated fibers, and wherein the base material is a matrix material of the fiber-reinforced vehicle part.
